(19) United States
(12) Patent Application Publication
(10) Pub. No.: US 2014/0274055 A1
(43) Pub. Date: Sep. 18, 2014

(54) METHOD AND APPARATUS FOR NETWORK NEIGHBOR CELL LIST OPTIMIZATION

(71) Applicant: Alcatel-Lucent USA Inc., Murray Hill, NJ (US)

(72) Inventors: Sundar R. Sriram, Aurora, IL (US); Kannan T. Konda, Aurora, IL (US)

(21) Appl. No.: 13/846,148

(22) Filed: Mar. 18, 2013

(51) Int. Cl. H04W 36/00

(52) U.S. Cl. CPC H04W 36/0083
USPC 455/436

(57) ABSTRACT

A method for optimizing a cellular network neighbor cell list (NCL) includes collecting performance measurement (PM) data relating to the performance of the cellular network; based on the processed and analyzed PM data, generating a proposal for optimization of the NCL; computing an SIB11 message consistent with the optimization proposal; checking the SIB11 message to ensure it can be encoded; and assuming the SIB11 message cannot be encoded, reverting to the generating step and generating a new proposal for optimization of the NCL, so as to optimize the NCL.

### BACKGROUND

The invention relates generally to network neighbor cell lists and more particularly but not exclusively to a method and apparatus for optimization of network neighbor cell lists.

The description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

The functions of the various elements shown in the figures may be provided through the use of dedicated hardware as well as hardware capable of executing software in association with appropriate software. It should be appreciated by those skilled in the art that any block diagrams herein represent conceptual views of illustrative circuitry embodying the principles of the invention.

### SUMMARY

In one set of embodiments, a method for optimizing a cellular network neighbor cell list (NCL) comprises: collecting performance measurement (PM) data relating to the performance of the cellular network; based on the processed and analyzed PM data, generating a proposal for optimization of the NCL; computing an SIB11 message consistent with the optimization proposal; checking the SIB11 message to ensure it can be encoded; and assuming the SIB11 message cannot be encoded, reverting to the generating step and generating a new proposal for optimization of the NCL, so as to optimize the NCL.

According to another set of embodiments, a method for optimizing a cellular network neighbor cell list (NCL) comprises: collecting performance measurement (PM) data relating to the performance of the cellular network; based on the PM data, generating a proposal for optimization of the NCL; computing an SIB11 message consistent with the optimization proposal; checking the SIB11 message to ensure it can be encoded; and assuming the SIB11 message can be encoded, applying the optimized NCL to the RNC, so as to optimize the NCL.

According to a further set of embodiments, a cellular network is provided, comprising: one or more Radio Network Controllers (RNC's); one or more Base Transmission Stations (BTS's); and an Operation and Administration Maintenance (OAM) module configured to collect, from at least one member of the group comprising the RNC's and the BTS's, PM data describing the performance of the network, and configured to use the PM data to generate a neighbor cell list (NCL) optimization proposal, wherein the OAM module further comprises an SIB Integrity Checker subsystem configured to determine if an SIB11 message generated by the system can be encoded, so as to optimize the NCL.

### DESCRIPTION OF THE DRAWINGS

The accompanying drawings provide visual representations which will be used to more fully describe various representative embodiments and can be used by those skilled in the art to better understand the representative embodiments disclosed herein and their advantages. In these drawings, like reference numerals identify corresponding elements.

FIG. 1 is a schematic block diagram of a prior art Universal Mobile Telecommunications System (UMTS) network architecture.

FIG. 2 is a schematic block diagram of a prior art UMTS network architecture.

FIG. 3 is a schematic block diagram of a UMTS network architecture for neighbor cell list optimization according to embodiments of the invention.

FIG. 4 is a flowchart of a method for network neighbor cell list optimization according to embodiments of the invention.

### DETAILED DESCRIPTION

While the present invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described. In the following description and in the several figures of the drawings, like reference numerals are used to describe the same, similar or corresponding parts in the several views of the drawings.

Optimizing a radio access network is a very complex, expensive and ongoing task. User Equipments (UE's) rely upon Neighbor Cell Lists (NCLs) while performing cell reselection and handovers. Maximizing network performance requires high quality NCLs that include all necessary neighbors and exclude unwanted neighbors. Operators generally use cellular network planning tools in one or more of the network designing and the network planning phases. Operators typically perform drive tests and determine network Key Performance Indicators (KPI's) in order to promote network optimization.

FIG. 1 is a schematic block diagram of a prior art Universal Mobile Telecommunications System (UMTS) network architecture 100.

The network architecture 100 comprises an access network 110 that is operably connected via a first asynchronous transfer mode (ATM) backbone 115A that has a first ATM backbone-core network interface 117 with a core network 120. The first ATM backbone 115A can, for example, be an Internet Protocol (IP) Network 115A. Comprised in access network 110 may be a first UE 140A, a second UE 140B, a first Radio Network Subsystem (RNS) 145A, a second RNS 145B, and an Operation and Administration Maintenance (OAM) module 147.

Comprised in first RNS 145A may be a first Base Transmission Station (BTS) 150A or first node B 150A, a first Radio Network Controller (RNC) 160A, and a second ATM backbone 115B. The second ATM backbone 115B can, for example, be an Internet Protocol (IP) Network 115B.

The first UE 140A may communicate wirelessly via a first UE-first BTS interface 165A with the first BTS 150A. The first BTS 150A may be operably connected with the first RNC 160A via the second ATM backbone 115B over a first BTS-first RNC interface 170A.

The first RNC 160A may be operably connected with the core network 120 via the first ATM backbone 115A over a first RNC-core network interface 180A. The first RNC-core network interface 180A may be one of a circuit switched interface 180A and a packet-switched interface 180A. The first RNC 160A may also be operably connected via a first RNC-OAM module interface 185A with the OAM module 147.

Comprised in second RNS 145B may be a second BTS 150B, a second RNC 160B, and a third ATM backbone 115C. The third ATM backbone 115B can, for example, be an Internet Protocol (IP) Network 115C.

The second UE 140B may communicate wirelessly via a second UE-second BTS interface 165B with the second BTS 150B. The second BTS 150B may be operably connected with the second RNC 160B via the third ATM backbone 115B over a second BTS-third ATM backbone interface 170B.

The second RNC 160B may be operably connected with the core network 120 via the first ATM backbone 115A over a second RNC-core network interface 180B. The second RNC-core network interface 180B may be one of a circuit switched interface 180B and a packet-switched interface 180B. The second RNC 160B may also be operably connected via a second RNC-OAM module interface 185B with the OAM module 147.

The first RNC 160A may be operably connected with the second RNC 160B via the first ATM backbone 115A over a first RNC-second RNC interface 190.

FIG. 2 is a schematic block diagram of a prior art UMTS network architecture 200.

The network architecture 200 may comprise an access network 210 and the core network 120. The access network 210 in turn may comprise a UE 140, the first RNS 145A, the second RNS 145B, and the OAM 147.

The first RNS 145A may comprise one or more of a first BTS 150A, a second BTS 150B, and a first RNC 160A.

The UE 140 may communicate wirelessly via one or more UE-BTS interfaces 165 with one or more of the BTS's 150A-150D. The UE may receive an NCL from one or more of the BTS's 150A-150D via one or more UE-BTS interfaces 165. The UE-BTS interface 165A, for example, may use a serving cell 265, also known as a source cell 265. The serving cell 265 may have neighboring cells 268.

The first BTS 150A may be operably connected with the first RNC 160A over a first BTS-first RNC interface 170A. Similarly, the second BTS 150B may be operably connected with the first RNC 160A over a second BTS-first RNC interface 170B.

The first RNC 160A may be operably connected with the core network 120 via a first RNC-core network interface 180A. The first RNC-core network interface 180A may be one of a circuit switched interface 180A and a packet-switched interface 180A.

The first RNC 160A may be operably connected with the OAM 147 via the first RNC-OAM interface 185A.

The first and second BTSs 150A and 150B may be respectively operably connected with the OAM 147 via respective first and second BTS-OAM interfaces 230A and 230B.

The second RNS 145B may comprise one or more of a third BTS 150C, a fourth BTS 150D, and a second RNC 160B.

The third BTS 150C may be operably connected with the second RNC 160B over a third BTS-second RNC interface 170C. Similarly, the fourth BTS 150D may be operably connected with the second RNC 160B over a fourth BTS-second RNC interface 170D.

The second RNC 160B may be operably connected with the core network 120 via a second RNC-core network interface 180B. The second RNC-core network interface 180B may be one of a circuit switched interface 180B and a packet-switched interface 180B.

The second RNC 160B may be operably connected with the OAM 147 via the second RNC-OAM interface 185B.

The third and fourth BTSs 150C and 150D may be respectively operably connected with the OAM 147 via respective third and fourth BTS-OAM interfaces 230C and 230D.

The first RNC 160A may be operably connected with the second RNC 160B over the first RNC-second RNC interface 190.

The UE 140 may obtain an NCL from the serving cell 265.

Planning tools and drive tests may be sufficient for pre-launch optimization of a network. However, planning tools and drive tests may not maximally optimize a network as conditions evolve over time. Moreover, planning tools and drive tests may not promote a network with maximal possible efficiency as conditions evolve over time. The input to the planning tool and the accuracy of the initial data determines the amount of optimization that needs to be performed on the network.

In most cases, the Neighbor Cell List (NCL) determined by the planning tool is not optimal. Network KPI's provide critical data on optimization. Identifying missing neighbors is often an activity that provides the greatest gains when performing Radio Frequency (RF) optimization. Each cell site has unique configuration data and comprises data that can be optimized, such as, for example, one or more of physical location, transmitter output power, primary scrambling code, uplink frequencies, downlink frequencies, parameters defining network configuration, and neighbor cell list.

Network performance directly impacts handover success rate, coverage and capacity, and quality of service (QOS). Optimally, the NCL may be regularly updated and optimized so as to improve network performance. Accordingly, certain problems that could otherwise occur may be avoided according to embodiments of the invention. Wrong or missing neighbor relations that might otherwise contribute to dropped calls may be avoided according to embodiments of the invention. Excessive neighbor relations in a cell that might otherwise contribute to an incorrect handover decision may be avoided according to embodiments of the invention. One or more of one-way neighbors and incorrect neighbors, which might otherwise contribute to poor network performance, may be avoided according to embodiments of the invention.

Also, addition and removal of BTSs requires ongoing reconfiguration and optimization. In a UMTS network, when a new BTS is brought into service, when configuration changes are made to an existing BTS, and/or when a reset is performed on an existing BTS, the affected BTS will perform a BTS setup. As part of this BTS setup procedure, the BTS will request to be audited by a Radio Network Controller (RNC). The BTS provides to the RNC at least one of information about one or more of the cells belonging to the RNC and information regarding local Cell Identifiers (Cell IDs).

For each cell, the RNC may perform a cell setup procedure during which the physical radio channels are configured. During the cell setup procedures, one or more of the common transport channels are set up and configured. Examples of possible transport channels include a Paging Channel (PCH), a Forward Access Channel (FACH), and a Resources Access Channel (RACH).

After cell setup has been completed, the BTS may request a System Information Update (SIU). As part of the SIU, several System Information Blocks (SIBs) messages may be transmitted. These SIBs comprise parameters such as, for example, one or more counters for changing Radio Resource Control (RRC) states and a UMTS Registration Area (URA). A Master Information Block (MIB) may comprise information about which of the SIBs are provided in response to receipt of a given Cell ID.

Subsequently, an SIB may be sent by the RNC to a BTS to be broadcast to the UEs. The RNC can also request the BTS to automatically create and update certain BTS-related system information of interest. Often, but not necessarily, the RNC will broadcast to the BTS the BTS-related system information of interest. For example, the RNC may request that the BTS automatically perform one or more of creating and updating information regarding scheduling of system broadcast information comprised in the RNC. As another example, the RNC may request that the BTS automatically perform one or more of creating and updating according to the scheduling parameters system information relating to BTS and comprised in the RNC. The BTS is responsible for broadcasting the received and updated system information relating to BTS.

The System Information Block 11 (SIB11) may comprise one or more Information Elements relating to the Cell Information List on which the UE may perform measurements. For example, the SIB11 may comprise one or more of an intra-frequency neighbor cell information list, an inter-frequency neighbor cell information list, and an inter-Radio Access Technology (RAT) neighbor cell information list. All the cells in the Cell Information List are either in the Active Set or the Monitored Set. The network can also request the UE to report on the detected cell list. The detected cell list comprises cells that the UEs can see but that were not comprised in the Cell Information List. The NCL can be optimized using detected set reporting.

3GPP imposes limitations on a network. First, the 3GPP TS 25.331 standards define the maximum number of neighbor cells monitored by a UE to 96. Comprised in this maximum 96 neighbor cells are 32 intra-frequency cells including the serving cell. Further comprised in the maximum 96 neighbor cells are 32 inter-frequency cells, a number that assumes the presence of the maximum number of additional carriers, that is, two additional carriers. Further comprised in the maximum 96 neighbor cells are 32 Global System for Mobile Communications (GSM) cells. Depending on the UE, these 32 GSM cells may be distributed across a maximum of 32 distinct GSM carriers.

A second set of limitations resulting from 3GPP stems from the fact that UE's read the neighbor cell list from the SIB11 message and optionally from the SIB12 message. According to embodiments of the invention, optionally, the SIB12 message can also be configured to carry neighbor cell information. If neighbors are configured using the SIB12 message, then the header of the SIB11 message must contain the information that there is a SIB12 message with data.

A Broadcast Transport Channel (BCH) is used to broadcast SIB messages using a fixed transport block size of 246 bits and a Transmission Time Interval (TTI) of approximately 20 milliseconds. A single transport block may be sent during each TTI. This results in a corresponding bit rate of approximately 12.3 kilobits per second (kbps). The Radio Link Control (RLC) and Medium Access Control (MAC) layers do not add any overhead, allowing the RRC layer to use all the 246 bits. The RRC layer adds its own header, which uses 24 bits and leaves a maximum of 222 bits for each segment of the Abstract Syntax Notation 1 (ASN.1) encoded SIB message. The RRC header is smaller and a maximum of 226 bits can be used when segmentation is not required and a complete SIB can be sent in a single transport block. A maximum of 16 segments can be used to transfer a single ASN.1-encoded SIB and hence the 3GPP standard limits the maximum size of the SIB message to a critical size, for example, to 3,552 bits (or 444 bytes).

However, 3,552 bits is typically not sufficient to transfer full information about 96 neighbor cells. Accordingly, the 3,552-bit critical size limit restricts the number of neighboring cells that can be included in an SIB11 message. The exact number of neighboring cells that can be included in the SIB11 message depends upon the quantity of Information Elements (IEs) associated with a corresponding neighbor. If the number of IEs associated with each neighbor increases, the number of corresponding neighbors that can be included decreases. The attributes of the data comprised in the IE's associated with a corresponding neighbor cell can be categorized as one of MD (Mandatory Default), CV (Conditional Value), and OP (Optional) attributes.

In case the encoding of the SIB11 message exceeds the 3GPP limitation, a warning alarm is sent to the Operations and Maintenance Console (OMC) to inform the user to re-adjust one or more of the number of neighboring cells and the number of IE's associated with our or more neighbor cells.

In order to have the smallest SIB11 message size and in order to accommodate the maximum possible neighbors in the NCL, all used IE's may be optimized. The optimizable parameters may be the IE's whose attributes are either MD or CV. An example of an IE that may be optimized is the UMTS Terrestrial Radio Access Absolute Radio Frequency Channel Number (UARFCN) uplink. If the distance between the uplink and the downlink frequency is the standard duplex distance, then the UARFCN uplink (Nu) may not be encoded. The band may be deduced from the UARFCN (Nd) and the Mobile Country Code. If a frequency does not belong to one of the bands as specified in 3GPP TS25.104, the UARFCN cannot typically be optimized.

An example of an IE that may be optimized is frequency information. If two consecutive cells have the same frequency information (Nu, if any, and Nd), then the frequency information IE of the second cell is not encoded. In order to have the best optimization, the new inter-frequency cells of the inter-frequency cell information list must be sorted. The first key sort is the UARFCN downlink (Nd) IE and the second key sort is the UARFCN uplink IE (Nu), if any. The second key sort is used to optimize the ASN.1-encoded cells with the same value of Nd.

A tradeoff exists between the numbers of neighboring cells populated and the number of IE parameters that deviate from the default values.

The optimizing of the IEs included in the SIB11 and extending of the neighboring cells impacts the performance of the RNC and the UE. The RNC may take more time to build the SIB11/SIB12 message, which may in turn have an impact on cell initialization time. Also, the UE may require more time and power to measure and monitor the additional neighbor cells that are received in the SIB11/SIB12.

In case the SIB11 encoding exceeds the 3GPP limitation, a warning alarm is sent to the OMC to inform the user to re-adjust either the number of neighboring cells or the data provisioned for the MD (Mandatory default), CV (Conditional on value), or OP (Optional) attributes of the neighboring cells. It is very easy to debug and resolve during initial deployments.

In case the RNC fails to encode and send the SIB11 message to the BTS during Cell Setup, an alarm is generated and sent to the OMC and the cell is marked as disabled or failed. During new BTS integration, this issue is easy to debug and resolve.

Following cell setup if the RNC fails to encode and send an SIB11 message to the BTS as part of optimization data changes or configuration data changes, when the cell is operational, an alarm is generated and sent to the OMC and the cell is marked to be in the enabled/degraded state. So the cell will continue to broadcast the current SIB11 message and will not use the new optimization data changes or the new configuration data changes. The cell will be marked as disabled or failed, and will have to undergo a cell setup procedure again. These issues are very difficult to debug and require more time and effort than the original optimization exercise. Also, they have a negative impact on the network performance and on KPI's.

The SIB11 messages are encoded in the RNC and a non-optimized NCL adds to the computing overhead on the RNC. Also, if the encoded SIB11 message exceeds a critical size after ASN.1 encoding is performed, it will not be sent to the BTS. For example, the critical size may be 3,552 bits. This may result in no neighbor cells being available for the UE to monitor, in turn potentially resulting in dropped calls. Also, if the BTS does not have a good SIB11 message to decode, the cell will not initialize properly. The RNC will generate one or more alarms if the SIB11 message encoding fails. Recovering the cell may require experts to identify the root cause of the problem and to fix the problem by a trial and error process of removing cells from the NCL. This process may be time-consuming and may lead to customer disapproval.

With the rapid increase in data traffic and smart phones, optimization of network performance becomes ever more critical. However, changes to promote optimization may, despite extensive advance planning, lead to degradation of KPI's below the levels experienced prior to the changes. Additionally, such changes may lead to failures of cells to properly initialize. Detailed investigation may be needed to determine the root causes of the difficulties, which could, for example, be attributable to a failure to properly encode the SIB11 messages.

Even if the number of neighbors is not changed, its parameters are modified from the default values as part of the optimization process, the number of bits used by the each neighbor cell may increase. This could potentially result in the size of the ASN.1-encoded SIB11 message exceeding the 3,552 bit critical size limit, in turn resulting in a failure to encode the SIB11 message.

According to embodiments of the invention, an integrity check is performed to compute the size of the SIB11 message and to ensure that its size is less than or equal to a critical size prior to performing an optimization data change or a configuration data change on the IE of a neighboring cell.

For example, the critical size may be 3,552 bits.

According to embodiments of the invention, the size of the current SIB11 message can be computed using an SIB11 message received from a BTS and using a snapshot of RNC data from the OMC. Accordingly, the ASN.1-encoded SIB11 message can be decoded and a proposed optimization rule can be generated to compute the bits used per IE.

According to embodiments of the invention, the size of the SIB11 message can then be computed both before and after the proposed optimization changes.

According to embodiments of the invention, a determination can be made whether the size of the SIB11 message will impact the operational state of the BTS or the cell.

According to embodiments of the invention, if it is determined that the SIB11 message is successfully encoded, the proposed optimization changes can be propagated. If it is determined that the SIB11 message is not successfully encoded, the proposed optimization changes can be iteratively reworked without impacting the operational network.

First, according to embodiments of the invention, the neighbor cells are identified. Next, according to embodiments of the invention, the functional neighbor cells are identified by measuring the Soft handover (SHO) KPI for each cell and its neighbors. According to embodiments of the invention, after ranking all the neighbor cells by their respective SHO KPI's, an NCL is computed for each cell.

FIG. 3 is a schematic block diagram of a UMTS network architecture 300 for neighbor cell list optimization according to embodiments of the invention.

The network architecture 300 may comprise an access network 310 and the core network 120. The access network 310 in turn may comprise the UE 140, the first RNS 145A, the second RNS 145B, and an OAM module 320.

The first RNS 145A may comprise one or more of a first BTS 150A, a second BTS 150B, and a first RNC 160A.

The UE 140 may communicate wirelessly via one or more UE-BTS interfaces 165 with one or more of the BTS's 150A-150D. The UE-BTS interface 150A, for example, may use a serving cell 265, also known as a source cell 265. The serving cell 265 may have neighboring cells 268.

The first BTS 150A may be operably connected with the first RNC 160A over the first BTS-first RNC interface 170A. Similarly, the second BTS 150B may be operably connected with the first RNC 160A over the second BTS-first RNC interface 170B.

The first RNC 160A may be operably connected with the core network 120 via the first RNC-core network interface 180A. The first RNC-core network interface 180A may be one of a circuit switched interface 180A and a packet-switched interface 180A.

The first RNC 160A may be operably connected with the OAM module 320 via the first RNC-OAM interface 185A.

The first and second BTSs 150A and 150B may be respectively operably connected with the OAM module 320 via respective first and second BTS-OAM interfaces 230A and 230B.

The second RNS 145B may comprise one or more of a third BTS 150C, a fourth BTS 150D, and a second RNC 160B.

The third BTS 150C may be operably connected with the second RNC 160B over a third BTS-second RNC interface 170C. Similarly, the fourth BTS 150D may be operably connected with the second RNC 160B over a fourth BTS-second RNC interface 170D.

The second RNC 160B may be operably connected with the core network 120 via a second RNC-core network interface 180B. The second RNC-core network interface 180B may be one of a circuit switched interface 180B and a packet-switched interface 180B.

The second RNC 160B may be operably connected with the OAM module 320 via the second RNC-OAM interface 185B.

The third and fourth BTSs 150C and 150D may be respectively operably connected with the OAM 230 via respective third and fourth BTS-OAM interfaces 230C and 230D.

The first RNC 160A may be operably connected with the second RNC 160B over the first RNC-second RNC interface 190.

The OAM module 320 may comprise a Performance Measurement (PM) subsystem 330. The PM subsystem 330 collects from one or more of the first RNC 160A and the second RNC 160B PM data describing the performance of the network. The PM data collected by the PM subsystem 330 may comprise one or more key performance indicators (KPI's).

The KPI's may comprise one or more of an identification of one or more proposed optimizations of Information Elements (IE's) comprised in the NCL, a log of network performance, an initial attachment success rate, a service request rate, a handover success rate, one or more HO failure reasons, a circuit switched call origination rate, a circuit switched call termination rate, a packet switched call origination rate, a packet switched call termination rate, an identification of one or more missing neighbors, an identification of one or more new neighbors to be added to the NCL, an identification of one or more excessive neighbor relations, an identification of one or more one-way neighbors, and an identification of one or more current neighbors to be deleted from the NCL, physical location, transmitter output power, primary scrambling code, uplink frequencies, downlink frequencies, parameters defining network configuration, coverage, capacity, and quality of service (QOS).

The OAM module 320 may comprise an SIB integrity Checker subsystem 370. As discussed below, the SIB Integrity Checker subsystem 370 may be configured to check the SIB11 message generated by the system in order to determine if the System Information Block 11 (SIB11) message can be encoded.

The PM subsystem 330 may be configured to gather PM data from the first RNC 160A over the first RNC-OAM interface 185A. Similarly, the PM subsystem 330 may be configured to gather PM data from the second RNC 160B over the first RNC-OAM interface 185B.

PM data may be roughly described as counters that are triggered when a certain type of procedure is executed. Examples of possible procedures include total attempts, successful attempts, trigger cause, and cause of a failure. Using PM data, all the KPI's can be computed at one or more of the network element level and the network level.

The PM subsystem 330 may also be configured to gather PM data from one or more of the BTSs 150A-150D over respective BTS-OAM interfaces 230A-230D.

The PM subsystem 330 may also be configured to process the PM data. The PM subsystem 330 may be operably connected via PM subsystem-optimization server interface 335 to an NCL optimization sever 340. The NCL optimization server may be further configured to identify the types of procedures and activities occurring in one or more of the first RAN 145A and the second RAN 145B. The NCL optimization server 340 may thereby help generate and optimize one or more KPI's for NCL's comprised in one or more of the first RAN 145A and the second RAN 145B. The HO failure causes may comprise one or more of a late HO, an early HO, an HO to the wrong cell, and a ping pong, i.e., an HO in which two cells continually exchange an HO back and forth. A ping pong HO may occur among adjacent cells. A ping pong HO may occur among non-adjacent cells. However, such an event is not likely given realistic conditions.

The optimization server 340 may analyze the PM data 330. The optimization server 340 may compute one or more KPI's describing one or more of areas where failures are occurring and proposed ways to further optimize the NCL's and thereby to further optimize the network's operation. This computation may occur automatically. This computation may be performed using criteria that are input by an operator prior to operation. Alternatively, this computation may be performed using criteria that are input by an operator during operation. The NCL optimization server 340 may use the computed KPI's to generate an NCL optimization proposal 350. The NCL optimization proposal 350 may comprise proposals regarding one or more of an identification of one or more missing neighbors, an identification of one or more new neighbors to be added to the NCL, an identification of one or more current neighbors to be deleted from the NCL, and an identification of one or more proposed optimizations of Information Elements (IE's) comprised in the NCL.

The NCL optimization server 340 may transmit the NCL optimization proposal 350 via interface 368 to the OAM module 320.

Following receipt by the OAM module 320 of the NCL optimization proposal 350, an optimized NCL may be generated by the OAM module 320 and checked by the SIB Integrity Checker 370 to determine if the System Information Block 11 (SIB11) message can be encoded. The SIB11 message may comprise one or more Information Elements (IE's) relating to the Cell Information List on which the UE may perform measurements. For example, the SIB11 may comprise one or more of an intra-frequency neighbor cell information list, an inter-frequency neighbor cell information list, and an inter-Radio Access Technology (RAT) neighbor cell information list. If the SIB11 does not pass the check by the SIB Integrity Checker 370, the SIB Integrity Checker sends an appropriate message to the OAM module 320. The OAM module 320 then proceeds to generate an alternative NCL optimization proposal 350 and the process proceeds as outlined above.

If the SIB11 message passes the check by the SIB Integrity Checker 370, it may then be transmitted over the first RNC-OAM module interface 185A to be applied by the first RNC 160A. Alternatively, or additionally, following receipt by the OAM module 320 of the NCL optimization proposal 350, an optimized NCL may be generated by the OAM module 320 and, assuming it passes the integrity check by the SIB Integrity Checker 370, may be transmitted over the second RNC-OAM module interface 185B to be applied by the second RNC 160B.

During the cell setup process, the first RNC 160A may perform ASN.1 encoding of the SIB11 message while enforcing 3GPP rules and limitations, after which it may be sent over the first BTS-first RNC interface 170A to the first BTS. Alternatively, or additionally, the SIB11 message may be sent over the second BTS-first RNC interface 170B to the second BTS. Alternatively, or additionally, during the cell setup process, the second RNC 160B may perform ASN.1 encoding of the SIB11 message while enforcing 3GPP rules and limitations, after which it may be sent over the third BTS-second RNC interface 170C to the third BTS. Alternatively, or additionally, the SIB11 message may be sent over the fourth BTS-second RNC interface 170D to the fourth BTS. A failure to encode the SIB11 message means the cell is unavailable and will result in degradation of the KPI's and of the network's performance.

The OAM module 320 is configured to decode the ASN.1-encoded SIB11 message. The OAM module 320 is further configured to compute the optimized NCL data. The optimized NCL data may then be compared with NCL data obtained from one or more of the first RNC 160A, the second RNC 160B, and the OAM module 320. This comparison can be used to determine the optimization scheme incorporated into the ASN.1 encoding of the SIB11 message. The OAM module 320 is further configured to compute the size of at least one of the IE's comprised in the SIB11 message.

According to embodiments of the invention, therefore, the size of the SIB11 message can be computed both before and after the proposed optimization, to determine if the SIB11 message can be effectively encoded by one or more of RNC's 160A and 160B.

When features such as hierarchical cell structure or hierarchical cell selection (HCS) are activated by a service provider, a reduction may result in the number of neighbor cells 268 that can be encoded by the RNC's 160A and 160B. According to embodiments of the invention, cell outage under such situations can be minimized.

One or more of the first through fourth BTSs 170A-170D may in turn transmit the optimized NCL to the UE 140 over BTS-UE interface 165.

The UE 140 may communicate wirelessly via one or more UE-BTS interfaces 165 with one or more of the BTS's 150A-150D. The UE may receive an NCL from one or more of the BTS's 150A-150D via one or more UE-BTS interfaces 165. The UE-BTS interface 165A, for example, may use a serving cell 265, also known as a source cell 265. The serving cell 265 may have neighboring cells 268. The UE 140 may obtain an optimized NCL from the serving cell 265. The optimized NCL may indicate one or more of the signal strength of the serving cell 265 and the signal strength of one or more neighbor cells 268 as defined in the NCL.

According to embodiments of the invention, the ASN.1-encoded SIB11 message is computed for each cell, using the snapshot data from the RNC and with the new parameter changes proposed to the NCL as part of the optimization proposal. If the SIB11 message can be successfully encoded in under a critical size limit, for example, in under 3,552 bits, the NCL optimization proceeds using the optimization proposal. On the other hand, if the encoding of the SIB11 message fails, the functional NCL is iterated to remove neighbor cells until the SIB11 message can be successfully encoded.

Alternatively, or additionally, parameter changes are made in the optimization proposal to ensure that the SIB11 message can be successfully encoded. The computation, according to embodiments of the invention, of the ASN.1-encoded SIB11 message size, can take place offline in the OMC. Advantageously, according to embodiments of the invention, network operation issues due to optimization changes are thereby eliminated. According to embodiments of the invention, the ASN.1 encoding of the SIB11 message on the OMC should be computed using the same optimization algorithm that is used on the RNC to ensure that the correct ASN-1 encoded message is sent to the BTS.

Embodiments of the invention may help smooth the process of NCL optimization. Embodiments of the invention may be applied to other messages that have multiple restrictions in terms of size and number of elements.

FIG. 4 is a flowchart of a method 400 for optimizing network neighbor cell lists. The order of the steps in the method 400 is not constrained to that shown in FIG. 4 or described in the following discussion. Several of the steps could occur in a different order without affecting the final result.

In block 410, PM data is collected regarding the performance of the network. The PM data may comprise key performance indicators (KPI's). Block 410 then transfers control to block 420.

In block 420, the PM data is processed. Block 420 then transfers control to block 430.

In block 430, the PM data is analyzed. Block 430 then transfers control to block 440.

In block 440, an NCL optimization proposal is generated. The NCL optimization proposal may be generated so as to optimize one or more KPI's.

The KPI's may comprise one or more of an identification of one or more proposed optimizations of Information Elements (IE's) comprised in the NCL, a log of network performance, an initial attachment success rate, a service request rate, a handover success rate, one or more HO failure reasons, a circuit switched call origination rate, a circuit switched call termination rate, a packet switched call origination rate, a packet switched call termination rate, an identification of one or more missing neighbors, an identification of one or more new neighbors to be added to the NCL, an identification of one or more excessive neighbor relations, an identification of one or more one-way neighbors, and an identification of one or more current neighbors to be deleted from the NCL, physical location, transmitter output power, primary scrambling code, uplink frequencies, downlink frequencies, parameters defining network configuration, coverage, capacity, and quality of service (QOS).

This generation of the optimization proposal may occur automatically. This generation may be performed using criteria that are input by an operator prior to operation. Alternatively, this generation may be performed using criteria that are input by an operator during operation. The NCL optimization proposal may comprise proposals regarding one or more of an identification of one or more missing neighbors, an identification of one or more new neighbors to be added to the NCL, an identification of one or more current neighbors to be deleted from the NCL, and an identification of one or more proposed optimizations of Information Elements (IE's) comprised in the NCL.

One specific approach to generating the NCL entails first identifying the neighbor cells, next identifying the functional neighbor cells by measuring the Soft handover (SHO) KPI for each cell and its neighbors, then ranking all the neighbors by their SHO KPI, and finally computing an NCL optimization proposal for each cell.

Block 440 then transfers control to block 450.

In block 450, an SIB11 message consistent with the NCL optimization proposal may be generated. Block 450 then transfers control to block 455.

In block 455, the SIB11 message using the optimized NCL may be checked for integrity to determine if the SIB11 message can be encoded and to determine what the message size would be. It may be determined if the SIB11 message is less than or equal to a critical size limit. For example, the critical size limit may be 3,552 bits. Block 455 then transfers control to block 460.

In block 460, it is queried whether the SIB11 message passes an integrity check. If it does pass, block 460 transfers control to block 470. If it does not pass, the process reverts to block 440 so that a new NCL optimization proposal may be generated.

In block 470, the NCL optimization changes are applied to the RNC. Block 470 then transfers control to block 410 so that the process can begin again. Alternatively (not shown), block 470 terminates the process.

While the above representative embodiments have been described with certain components in exemplary configurations, it will be understood by one of ordinary skill in the art that other representative embodiments can be implemented using different configurations and/or different components. For example, it will be understood by one of ordinary skill in the art that the order of certain fabrication steps and certain components can be altered without substantially impairing the functioning of the invention.

For example, the SIB Integrity Checker may be free-standing from the OAM module rather than being comprised in the OAM. The NCL optimization server may process the PM data rather than the PM subsystem.

The present inventions may be embodied in other specific apparatus and/or methods. The described embodiments are to be considered in all respects as only illustrative and not restrictive. In particular, the scope of the invention is indicated by the appended claims rather than by the description and figures herein. All changes that come within the meaning and range of equivalency of the claims are to be embraced within their scope.

The representative embodiments and disclosed subject matter, which have been described in detail herein, have been presented by way of example and illustration and not by way of limitation. It will be understood by those skilled in the art that various changes may be made in the form and details of the described embodiments resulting in equivalent embodiments that remain within the scope of the appended claims. Moreover, fabrication details are merely exemplary; the invention is defined by the following claims.

We claim:

1. A method for optimizing a cellular network neighbor cell list (NCL), comprising:
collecting performance measurement (PM) data relating to the performance of the cellular network;
based on the processed and analyzed PM data, generating a proposal for optimization of the NCL;
computing an SIB11 message consistent with the optimization proposal;
checking the SIB11 message to ensure it can be encoded; and
assuming the SIB11 message cannot be encoded, reverting to the generating step and generating a new proposal for optimization of the NCL, so as to optimize the NCL.

2. The method of claim 1, wherein the PM data comprises one or more key performance indicators (KPI's).

3. The method of claim 2, wherein the KPI's comprise one or more of an identification of one or more proposed optimizations of Information Elements (IE's) comprised in the NCL, a log of network performance, an initial attachment success rate, a service request rate, a handover success rate, one or more HO failure reasons, a circuit switched call origination rate, a circuit switched call termination rate, a packet switched call origination rate, a packet switched call termination rate, an identification of one or more missing neighbors, an identification of one or more new neighbors to be added to the NCL, an identification of one or more excessive neighbor relations, an identification of one or more one-way neighbors, an identification of one or more current neighbors to be deleted from the NCL, physical location, transmitter output power, primary scrambling code, uplink frequencies, downlink frequencies, parameters defining network configuration, coverage, capacity, and quality of service (QOS).

4. The method of claim 1, wherein the step of generating comprises generating an NCL optimization proposal configured to optimize one or more KPI's.

5. The method of claim 1, wherein the method is performed automatically.

6. The method of claim 1, wherein the step of generating is performed automatically.

7. The method of claim 1, wherein the step of generating is performed using previously specified criteria.

8. The method of claim 1, wherein the step of checking comprises determining the size of the SIB11 message.

9. The method of claim 8, wherein the step of checking comprises determining whether the size of the SIB11 message is less than or equal to a critical size.

10. The method of claim 9, wherein the critical size is 3,552 bits.

11. The method of claim 1, wherein the network is a Universal Mobile Telecommunications System (UMTS) network.

12. The method of claim 1, wherein the step of generating comprises:
identifying neighbor cells;
identifying functional neighbor cells by measuring the soft handover (SHO) KPI for each cell and its neighbors;
ranking the neighbor cells by their SHO KPI's; and
computing an NCL optimization proposal for each cell.

13. A method for optimizing a cellular network neighbor cell list (NCL), comprising:
collecting performance measurement (PM) data relating to the performance of the cellular network;
based on the PM data, generating a proposal for optimization of the NCL;
computing an SIB11 message consistent with the optimization proposal;
checking the SIB11 message to ensure it can be encoded; and
assuming the SIB11 message can be encoded, applying the optimized NCL to the RNC, so as to optimize the NCL.

14. A cellular network, comprising:
one or more Radio Network Controllers (RNC's);
one or more Base Transmission Stations (BTS's); and
an Operation and Administration Maintenance (OAM) module configured to collect, from at least one member of the group comprising the RNC's and the BTS's, PM data describing the performance of the network, and configured to use the PM data to generate a neighbor cell list (NCL) optimization proposal,
wherein the OAM module further comprises an SIB Integrity Checker subsystem configured to determine if an SIB11 message generated by the system can be encoded, so as to optimize the NCL.

15. The system of claim 14, wherein the PM data comprises one or more key performance indicators (KPI's).

16. The system of claim 15, wherein the KPI's comprise one or more of an identification of one or more proposed optimizations of Information Elements (IE's) comprised in the NCL, a log of network performance, an initial attachment success rate, a service request rate, a handover success rate, one or more HO failure reasons, a circuit switched call origination rate, a circuit switched call termination rate, a packet switched call origination rate, a packet switched call termination rate, an identification of one or more missing neighbors, an identification of one or more new neighbors to be added to the NCL, an identification of one or more excessive neighbor relations, an identification of one or more one-way neighbors, an identification of one or more current neighbors to be deleted from the NCL, physical location, transmitter output power, primary scrambling code, uplink frequencies, downlink frequencies, parameters defining network configuration, coverage, capacity, and quality of service (QOS). of data on initial attaches, service requests, handovers (HO's), circuit switched call originations, circuit switched call terminations, packet switched call originations, and packet switched call terminations.

17. The system of claim 14, wherein the OAM module generates the NCL optimization proposal automatically.

18. The system of claim 14, wherein the SIB Integrity Checker determines the size of the SIB11 message.

19. The method of claim 18, wherein the SIB Integrity Checker determines whether the size of the SIB 11 message is less than or equal to a critical size.

20. The method of claim 14, wherein the network is a Universal Mobile Telecommunications System (UMTS) network.
